(19) United States
(12) Patent Application Publication
(10) Pub. No.: US 2008/0088051 A1
(43) Pub. Date: Apr. 17, 2008

(54) Rotational molding paint-ready polyurethane

(76) Inventor: Robert Harvey Moffett, Landenberg, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/974,691

(22) Filed: Oct. 16, 2007

Related U.S. Application Data
(60) Provisional application No. 60/852,206, filed on Oct. 16, 2006.

(51) Int. Cl. B29C 71/00

(52) U.S. Cl. 264/129; 264/310; 264/334; 264/338; 528/12

(57) ABSTRACT

A method for producing a paint-ready polyurethane molded article is disclosed. The article is produced by rotationally molding a reactive polyurethane in a mold to which has been applied a mold release composition which comprises a volatile siloxane solvent; a combination of a polysilsesquioxane polymer or copolymer and a functionally-terminated polydimethylsiloxane; and optionally a catalyst, a co-solvent, or both. There is further provided a process to produce a painted polyurethane molded article wherein the molded article is free of mold release composition without cleaning.

### CROSS-REFERENCE TO RELATED APPLICATION

This application claims priority to U.S. Provisional Application No. 60/852,206, filed on Oct. 16, 2006.

### FIELD OF THE INVENTION

This invention relates to a molding process to produce a polyurethane molded article. More particularly, the process relates to rotational molding wherein a mold release agent is applied to a mold as a semi-permanent coating.

### BACKGROUND OF THE INVENTION

Many industrial molding operations require the use of release agents to reduce the tendency of a molded product to stick to the mold. Included in these operations is rotational molding, for example, rotational molding of polyurethane articles. Release coatings are used in rotational and other molding processes to prevent the molded article from adhering to the mold surface. Rotational molding of polyurethane articles presents particular difficulties due to the extremely adherent nature of polyurethane to mold release compositions.

Many release agents such as silicone-based release agents need to be frequently re-applied to the surface of a mold, in some cases after each use of the mold. This may be due to deterioration of the release agent coating on the mold. Alternatively the mold release agent may have greater affinity for the molded article, such as polyurethane, and thus, upon removal of the article from the mold, the article has a portion of, or may even have most of, the mold release agent on its surface.

It is desirable to have a permanent or at least semi-permanent mold release agent composition for a rotational mold, especially a mold for use with polyurethanes, as re-applying mold release agent adds time and cost to molded articles.

Frequently molded articles are coated, e.g., painted after molding Adherence of release agent to a molded article interferes with painting of the molded article. That is, mold release agent on surface of molded article prevents binding to article surface by paint or other protective films. Thus, painting the molded article will result in an uneven coating of paint and portions of the surface may remain uncoated. To avoid uneven paint coatings, it is common to chemically and/or physically clean molded articles prior to painting. Such cleaning methods are time consuming, labor intensive, may damage the surface of the molded article and increase costs of producing molded articles.

One common procedure to treat polyurethane molded articles is to wash the surface of the article with an organic solvent, such as acetone, to remove release agent which adhered to the surface of the polyurethane molded article. Subsequently, the surfaces are sandblasted to render them paint-ready, that is, sandblasting provides a surface to which paint will more readily adhere.

Alternatively, more sophisticated methods have been proposed to clean surfaces of molded articles to promote adhesion, e.g., of paint, thereto. For example, U.S. Pat. No. 4,803,021 discloses a method to remove surface coatings of mold release agents by ultraviolet laser. U.S. Pat. No. 6,551,407 discloses a method to clean mold release agents from surfaces of molded articles by exposing the surface to continuous ultraviolet light at about 0.1 to 20 kW in order to volatize the mold release agent. U.S. Pat. No. 5,512,123 discloses a method to improve bonding to surfaces, such as those coated with mold release products by irradiating with optical energy (160-5000 nm) to photodecompose a target molecule, e.g., mold release agent, from the irradiated surface.

While the aforementioned methods provide molded articles with surfaces more capable of bonding to protective coatings, such as paints, they involve time, volatile organic chemicals, and/or sophisticated equipment. Thus, there is a need for a method to provide a molded article that is paint-ready, without the need for chemical or physical washing procedures following removing the article from a mold. The present invention meets this need.

### SUMMARY OF THE INVENTION

This invention is directed to a mold release composition comprising (a) at least one volatile siloxane solvent, (b) a combination of a polysilsesquioxane polymer or copolymer and a functionally-terminated polydimethylsiloxane, and optionally (c) a catalyst, a co-solvent, or both.

There is further provided a method to provide a paint-ready polyurethane molded article, especially a molded article produced by rotational molding. The method comprises (a) combining a volatile siloxane solvent, a combination of a polysilsesquioxane polymer or copolymer and a functionally-terminated polydimethylsiloxane, and optionally a catalyst, a co-solvent, or both, to produce a mold release composition; (b) applying the mold release composition onto a mold, (c) optionally curing the mold release composition; (d) charging to the treated mold a reactive polyurethane system; (e) rotating and optionally heating the mold while rotating to form a molded polyurethane article within the mold; (f) optionally cooling the mold; and (g) removing the molded polyurethane article from the mold wherein the mold release composition does not adhere to the surface of the article. The molded article is ready to paint without need for cleaning by chemical or physical methods.

Surprisingly, in view of known tendencies of silicone-based mold release agents to adhere to polyurethane molded articles, when the mold release composition described herein is applied to a mold and polyurethane molded article is produced therein by rotational molding, the mold release remains adhered to the surface of the mold and does not adhere to the surface of the polyurethane molded article. Multiple release from the mold can be achieved without re-applying the mold release composition.

There is further provided a process to prepare a painted polyurethane molded article comprising (a) providing a mold release composition comprising a volatile siloxane solvent, a combination of a polysilsesquioxane polymer or copolymer and a functionally-terminated polydimethylsiloxanes, and optionally a catalyst, a co-solvent, or both, to produce a mold release composition; (b) applying the mold release composition onto a mold, (c) optionally curing the mold release composition; (d) charging to the treated mold a reactive polyurethane system; (e) rotating and optionally heating the mold while rotating to form a molded polyurethane article within the mold; (f) optionally cooling the mold; (g) removing the molded polyurethane article from the mold wherein the mold release composition does not adhere to the surface of the article; and (h) painting the molded article without chemically or physically cleaning the article prior to painting.

### DETAILED DESCRIPTION OF THE INVENTION

Trademarks and trade names used herein are shown in upper case.

According to the invention, the term “mold” means one or more shape-determining surfaces. The composition and method of this invention are particularly applicable to rotational molding.

### Mold Release Composition

Any volatile siloxane can be used in the composition of this invention. The term “volatile siloxane” refers to a rapidly evaporating siloxane under the temperature and pressure of use. Typically, it can have an evaporation rate of >0.01 relative to n-butyl acetate which has an assigned value of 1.

A suitable solvent can have the formula of R(R₂SiO)ₓSiR₃ or (R₂SiO)_{y} where each R can be the same or different and is preferably, an alkyl group, alkoxy group, a phenyl group, a phenoxy group, or combinations of two or more thereof; having 1 to about 10, preferably 1 to about 8 carbon atoms per group. R can also be a halogen. The most preferred R is a methyl group and can be substituted with a halogen, an amine, or other functional group. Subscript x can be a number from 1 to about 20, preferably 1 to 10. Subscript y can be a number from 3 to about 20, preferably 3 to about 10. A preferred solvent has a molecular weight in the range between about 50 and about 1,000 and a boiling point less than about 300° C., preferably lower than 250° C., more preferably lower than 200° C., and most preferably lower than 150° C.

Methyl siloxanes are preferred. Examples of suitable methyl siloxanes include, but are not limited to, hexamethyldisiloxane, hexamethylcyclotrisiloxane, 2,5-dichloro-1,1,3,3,5,5,-hexamethyltrisiloxane, 1,3-dimethyltetramethoxydisiloxane, 1,1,1,3,5,5,5,-heptamethyltrisiloxane, 3-(heptafluoropropyl)trimethysiloxane, octamethyltrisiloxane, octamethyltetrasiloxane, octamethylcyclotetrasiloxane, decamethyltetrasiloxane, decamethylcyclopentasiloxane, dodecamethylpentasiloxane, and dodecamethylcyclohexasiloxane, and combinations of two or more thereof. Most preferred are selected from the group consisting of octamethylcyclotetrasiloxane; decamethyltetrasiloxane; octamethyltrisiloxane, hexamethyldisiloxane and combinations thereof. The volatile siloxane can be a combination of two or more methyl siloxanes, such as, for example, octamethylcyclotetrasiloxane and octamethyltrisiloxane.

The mold release comprises a polysilsesquioxane polymer or copolymer. Examples of suitable polysilsesquioxane polymer or copolymer include polyalkyl- or polyarylsilsesquioxane polymers and copolymers, wherein alkyl is typically hydrogen, methyl, ethyl, and aryl is typically phenyl. The polysilsesquioxane may be a copolymer of silsesquioxanes, e.g., a copolymer of methylsilsesquioxane and phenylsilsesquioxane or a copolymer of a silsesquioxane and a siloxane, e.g., a functionally-terminated siloxane.

The mold release comprises a functionally-terminated polydimethylsiloxane. By “functionally-terminated polydimethylsiloxane” it is meant a mono- or di-hydroxy- or alkoxy-terminated polydimethylsiloxane, or a combination thereof. The alkoxy group can be, for example, methoxy or ethoxy. Preferably the functionally-terminated polydimethylsiloxane is a mono- or di-hydroxy- or mono- or di-methoxy-terminated polydimethylsiloxane, or a combination thereof.

The above-disclosed silsesquioxanes and siloxanes are generally available commercially, for example, from Dow Corning Chemicals, Midland, Mich., and General Electric, Fairfield, Conn.

Any organic solvent, preferably substantially free of water such as, for example, a hydrocarbon or halogenated hydrocarbon, that is inert towards other components of the composition, is compatible with the volatile siloxane and is volatile to evaporate rapidly when applied to the mold surface can be used as co-solvent. A co-solvent can also reduce the viscosity of the composition and promote the release of a polymer from a mold. Preferably, a co-solvent has a normal boiling point below about 300° C., preferably below 200° C., and most preferably below 150° C., depending on the temperature of the mold release composition to be applied to a mold. The lower the temperature the mold release composition to be allied, the lower the boiling point solvent is preferred and vice versa. Examples of suitable co-solvents include, but are not limited to, octane, decane, cyclohexane, toluene, xylene, methylene chloride, methylene dichloride, ethylene dichloride, carbon tetrachloride, chloroform, perchloroethylene, acetone, methylethyl ketone, ethyl acetate, tetrahydrofuran, dioxane, white spirit, mineral spirits, naphtha, and combinations of two or more thereof.

The mold release composition can also comprise additional compounds such as reactive silanes, modified fumed silica, surfactants, fluoropolymers such as polytetrafluoroethylene, waxes, fatty acids such as stearic acid, fatty acid salts such as metal stearates, finely dispersed solids such as talc, emulsifiers, biocides, corrosion inhibitors.

Each component disclosed above can be present in the composition in an effective amount sufficient to effect the suitable release of a molded article. For example, based on the total weight of the composition, the solvent can be present in the composition in the range of from about 10 to about 99%; the combination of a polysilsesquioxane polymer or copolymer and a functionally-terminated polydimethylsiloxane can be present in the composition in the range of from about 0.1 to about 90%. The polysilsesquioxane polymer can be present in an amount of 10 to 90% based on the total combined weight of the polysilsesquioxane and polydimethylsiloxane polymers. Conversely, the polydimethylsiloxanes polymer can be present in an amount of 90 to 10% based on the total combined weight of the polysilsesquioxane and polydimethylsiloxane polymers. A co-solvent, if used, can be present in the composition in such range that the sum of solvent and co-solvent is about 10 to about 99%, provided that the solvent is present at least about 10%, preferably at least 20%. Other components, if present, can be in the range of from about 0.01 to about 10%.

Any catalyst that can catalyze or enhance the curing of a composition comprising a volatile siloxane, combination of a polysilsesquioxane polymer or copolymer and a functionally-terminated polydimethylsiloxane and a solvent can be used herein. A preferred catalyst is an organic titanium compound. Titanium tetrahydrocarbyloxides, also referred to as tetraalkyl titanates herein, are most preferred organic titanium compounds because they are readily available and effective. Examples of suitable titanium compounds include those expressed by the formula Ti(OR)₄ where each R is individually selected from an alkyl, cycloalkyl, alkaryl, hydrocarbyl radical containing from 1 to about 30, preferably 2 to about 18, and most preferably 2 to 12 carbon atoms per radical and each R can be the same or different. Titanium tetrahydrocarbyloxides in which the hydrocarboxyl group contains from 2 to about 12 carbon atoms per radical which is a linear or branched alkyl radical are most preferred because they are relatively inexpensive, more readily available, and effective in curing the composition. Suitable titanium compounds include, but are not limited to, titanium tetraethoxide, titanium tetrapropoxide, titanium tetraisopropoxide, titanium tetra-n-butoxide, titanium tetrahexoxide, titanium tetra 2-ethylhexoxide, titanium tetraoctoxide, and combinations of two or more thereof. These catalysts are commercially available. For example, TYZOR® TPT and TYZOR® TBT (tetra isopropyl titanate and tetra n-butyl titanate, respectively) are available from E. I du Pont de Nemours and Company, Wilmington, Del.

Also suitable are titanium ethylacetoacetates, such as TYZOR DC, TYZOR BEAT and TYZOR IBAY organic titanates, also available from DuPont.

Other suitable catalysts include a compound or element of VIII group of the periodic table of the elements such as platinum, palladium, iron, zinc, rhodium, and nickel as well as a tin or zirconium compound. Examples of other suitable catalysts include, but are not limited to, dibutyltin diacetate, dibutyl dilaurate, zinc acetate, zinc octoate, zirconium octoate, and combinations of two or more thereof. For example, dibutyltin diacetate can be used independently or in combination with a titanium compound.

Each of the catalysts disclosed above can be used in the composition in the range of from about 0.01 to about 10 weight % relative to the total combined weight of the polysilsesquioxane and polydimethylsiloxanes polymers.

The mold release composition can be produced by any means known to one skilled in the art such as, for example, combining all of the components disclosed above. Preferably, the catalyst is added after the polysilsesquioxane and polydimethylsiloxanes polymers, solvent, and optional co-solvent are combined.

### Reactive Polyurethane System

A reactive polyurethane system suitable for use in the method of this invention comprises at least one organic polyisocyanate, at least one compound having at least two active hydrogen atoms, and a polyurethane catalyst.

Any organic polyisocyanate capable of yielding polyurethane can be used in the method of this invention. A polyisocyanate comprises two or more isocyanate groups. Aliphatic, cycloaliphatic, aromatic polyisocyanates can be used. In particular, low molecular weight diisocyanates having the general formula OCN—R—NCO wherein R represents aliphatic, cycloaliphatic, or aromatic radical, optionally with alkyl substitution having from 1 to 30 carbon atoms, can be used.

Polyisocyanates suitable for this invention include, for example, tetramethylene diisocyanates, hexamethylene diisocyanates, octamethylene diisocyanates, decamethylene diisocyanates, and their alkyl substituted homologs, 1,2-, 1,3- and 1,4-cyclohexane diisocyanates, 2,4- and 2,6-methyl-cyclohexane diisocyanates, 4,4′- and 2,4′-dicyclohexyl diisocyanates, 4,4′- and 2,4′-dicyclohexylmethane diisocyanates, 1,3,5-cyclohexane triisocyanates, isocyanatomethylcyclohexane isocyanates, isocyanatoethylcyclohexane isocyanates, bis(isocyanatomethyl)cyclohexane diisocyanates, 4,4′- and 2,4′-bis(isocyanatomethyl)dicyclohexane, isophorone diisocyanate, 1,2-, 1,3-, and 1,4-phenylene diisocyanates, 2,4- and 2,6-toluene diisocyanate, 2,4′-, 4,4′- and 2,2-biphenyl diisocyanates, 2,2′-, 2,4′- and 4,4′-diphenylmethane diisocyanates, saturated (hydrogenated) polymethylenepolyphenylene polyisocyanates, polymethylenepolyphenylene polyisocyanates (polymeric MDI), and aromatic aliphatic isocyanates such as 1,2-, 1,3-, and 1,4-xylylene diisocyanates.

Specific polyisocyanates include m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, diphenyl methane-4,4′-diisocyanate, 4,4′-diphenylenediisocyanate, 3,3′-dimethoxy-4,4′-biphenyldiisocyanate, 3,3′-dimethyl-4,4′-biphenyldiisocyanate, and 3,3′-dimethyldiphenylmethane-4,4′-diisocyanate; triisocyanates such as 4,4′,4″-triphenylmethanetriisocyanate, polymethylenepolyphenylene isocyanate, toluene-2,4,6-triisocyanate; and the tetraisocyanates such as 4,4′-dimethyldiphenylmethane-2,2′,5,5′-tetraisocyanate. Especially useful are polymethylenepolyphenylene polyisocyanates.

Polyisocyanates containing heteroatoms may also be used such as, for example, those derived from melamine. Polyisocyanates modified by carbodiimide or isocyanurate groups can also be used. Liquid carbodiimide group- and/or isocyanurate ring-containing polyisocyanates having an isocyanate content of 15 to 33.6 weight %, preferably 21 to 31 weight % can also be used.

Polyisocyanates based on one or more of 4,4′-, 2,4′-, and/or 2,2′-diphenylmethane diisocyanate (MDI) and/or polyisocyanates based on 2,4- and/or 2,6-toluene diisocyanate (TDI) are preferred, including polymethylenepolyphenylene polyisocyanates (polymeric MDI).

Other isocyanate-terminated quasi-prepolymers can also be used such as those prepared by reacting excess organic polyisocyanate or mixtures thereof with a minor amount of an active hydrogen-containing compound. Suitable active hydrogen containing compounds for preparing these quasi-prepolymers are those containing at least two active hydrogen-containing groups which are isocyanate reactive. Typifying such compounds are hydroxyl-containing polyesters, polyether polyols, hydroxyl-terminated polyurethane oligomers, polyhydric polythioethers, ethylene oxide adducts of phosphorous-containing acids, polyacetals, aliphatic polyols, aliphatic thiols including alkane, alkene, and alkyne thiols having two or more SH groups, as well as mixtures thereof. Compounds which contain two or more different groups within the above-defined classes may also be used such as, for example, compounds which contain both a SH group and an OH group. Highly useful quasi-prepolymers are disclosed in U.S. Pat. No. 4,791,148 to Riley et al., the disclosure of which with respect to the quasi-prepolymers is hereby incorporated by reference.

The compound having at least two active hydrogen atoms is an organic compound containing isocyanate-reactive groups such as, for example, amino alcohols, polyols, polyamines, polyacids, polymercaptans and combinations of two or more thereof. Suitable amino alcohols include monoethanolamine, diethanolamine, triethanolamine, N-methyldiethanolamine, N-propyldiethanolamine, N-isopropyldiethanolamine, N-butyldiethanolamine, N-isobutyldiethanolamine, triisopropanolamine, tripropanolamine, tributanolamine, triisobutanolamine, or combinations of two or more thereof.

Any suitable polyol may be used. The polyol can be aliphatic, cycloaliphatic, aromatic and/or heterocyclic alcohols having at least 2 carbon atoms, and may have 20 or more carbon atoms. Examples include diols, triols and tetrols which can include inert substituents, for example, chlorine and bromine, and/or may be unsaturated. Examples of suitable polyhydric alcohols include: ethylene glycol; 1,2- and 1,3-propylene glycol; 1,4- and 2,3-butanediol; 1,6-hexanediol; 1,8-octanediol; neopentyl glycol; 1,4-bishydroxymethyl cyclohexane; 2-methyl-1,3-propane diol; glycerin; trimethylolpropane; trimethylolethane; 1,2,6-hexanetriol; 1,2,4-butanetriol; pentaerythritol; quinitol; mannitol; sorbitol; formitol; α-methyl-glucoside; diethylene glycol; triethylene glycol; tetraethylene glycol and higher polyethylene glycols; dipropylene glycol and higher polypropylene glycols as well as dibutylene glycol and higher polybutylene glycols. Especially suitable polyols are oxyalkylene glycols, such as diethylene glycol, dipropylene glycol, triethylene glycol, tripropylene glycol, tetraethylene glycol, tetrapropylene glycol, trimethylene glycol and tetramethylene glycol.

Polyether polyols are also within scope of suitable polyols. Polyether polyols are those compounds having molecular weight in the range of 500 to 10,000, preferably, 1000-4000, with hydroxy or amine functionality of at least 2, obtained by condensation of compounds containing at least two active hydrogen atoms, such as those listed hereinabove. Examples of polyether polyols include polyoxypropylene glycol and polytetramethylene ether glycol.

Polyester polyols are also within scope of suitable polyols. Polyester polyols can be produced by any means known to one skilled in the art such as, for example, from a polyol, such as ethylene glycol; 1,2- and 1,3-propylene glycol; 1,4- and 2,3-butanediol; and a carbonyl compound such as a carboxylic acid or its derivative, such as an anhydride or ester Examples of suitable carboxylic acids include succinic acid, adipic acid, suberic acid, terephthalic acid, and isophthalic acid, corresponding acid anhydride derivatives or esters, such as methyl esters.

The polyurethane catalyst may be any catalyst capable of converting isocyanate and compound with active hydrogen atoms to a polyurethane. Suitable catalysts include an aminoalcohol, a metal esterification catalyst, or combinations of two or more thereof. Examples of aminoalcohols include N-alkylalkanolamines and alkanolamines where the alkyl groups are methyl, ethyl, propyl, isopropyl, isobutyl, or butyl. The aminoalcohol can be a tertiary amine. Specific examples include N-methyldiethanolamine, N-propyldiethanolamine, N-isopropyldiethanolamine, N-butyldiethanolamine, N-isobutyldiethaolamine, triisopropanolamine, triethanolamine, tripropanolamine, tributanolamine, triisobutanolamine, and combinations of two or more thereof.

A metal esterification catalyst can be organic and inorganic salts of, coordination complexes of and organometallic derivatives include those of bismuth, lead, tin, titanium, iron, antimony, uranium, cadmium, cobalt, thorium, aluminum, mercury, zinc, nickel, cerium, molybdenum, vanadium, copper, manganese, titanium, and zirconium. Examples of metal esterification catalysts include bismuth nitrate, lead 2-ethylhexoate, lead benzoate, lead oleate, dibutyltin dilaurate, tributyltin, butyltin trichloride, stannic chloride, stannous octoate, stannous oleate, dibutyltin di(2-ethylhexoate), ferric chloride, antimony trichloride, antimony glycolate, tin glycolate, a titanate, a titanium chelate. These are readily available from a commercial source. For example, TYZOR® TPT (tetraisopropyl titanate), TYZOR® TBT (tetrabutyl titanate), TYZOR® LA (bis-ammonium titanium lactate), and other TYZOR® products are readily available from E. I. du Pont de Nemours and Company, Wilmington, Del. The catalyst can be present in a catalytic amount such as about 1 to about 10000 parts per million (ppm) by weight of the composition.

The reactive polyurethane system can further comprise other additives such as, for example, cross-linking agents, UV absorbers and light stabilizers, processing aids, viscosity reducers, flame retardants, dispersing agents, plasticizers, antioxidants, compatibility agents, and fillers and pigments. The use of such additives is well known to those skilled in the art and the detailed description of which is omitted herein for the interest of brevity.

### Method

The method of this invention comprises applying a mold release composition to the surface of a mold wherein the mold release composition is prepared by combining a volatile siloxane solvent, the polysilsesquioxane and polydimethylsiloxanes polymers, and optionally a catalyst, a co-solvent, or both. Optionally the mold release composition is cured on the mold. The mold release composition provides an adherent coating on the mold that is capable of rendering multiple releases from the mold without need for reapplication. That is, a semi-permanent coating on the mold is provided.

Application of the mold release composition can be carried out by any means known to one skilled in the art such as, for example, spraying, brushing, wiping, dipping, and combinations of two or more thereof. Any surface of a shape-determining mold can be applied with the release composition. Curing can be carried out by any means known to one skilled in the art such as curing at ambient temperature such as from about 25° C. to about 200° C. under a pressure that accommodates the temperature range such as, for example, atmospheric pressure for about one second to about 2 hours. Generally, curing is carried out at the temperature and pressure at which the molding is being carried out.

A reactive polyurethane system as described hereinabove is charged to the mold. The reactive polyurethane system is prepared by combining at least one organic polyisocyanate, at least one compound having at least two active hydrogen atoms, and a polyurethane catalyst. Once components of the reactive polyurethane system are combined, the system is charged to a mold. The time between combining the components and charging the system to the mold may be relatively short, e.g., less than 5 minutes, may be less than 2 minutes. An appropriate time can be readily determined experimentally by processes known to those skilled in the art. The objective is to avoid allowing the polyurethane reactive system to cure before the article can form in the shape of the mold.

The method of this invention is particularly suitable for rotationally molding the reactive polyurethane system. Rotational molding processes are well known to those skilled in the art. In this process a mold is rotated to form a molded polyurethane article within the mold. Rotational molding, sometimes referred to as “rotomolding” is a plastics processing technique. Rotational molding comprises charging to a mold, a specific amount of a polymer or prepolymer, then rotating the mold, generally through heating and cooling cycles on a rotational mold machine. The polymer or prepolymer reacts and/or fuses to form a molded article within the mold. Once the cycle is complete, the molded article is removed from the mold.

Optionally the mold is heated while rotating. Temperature depends on the polyurethane system composition. Reaction of components of the reactive polyurethane system is exothermic. The reaction energy increases temperature of the mold and its contents. Typically no additional heat is added to sustain production of a molded polyurethane article within the mold.

When the mold is heated while rotating or if temperature has increased due to reaction of the polyurethane system, rotating continues through a cooling step after the molded polyurethane article has been formed within the mold. The mold is opened and the molded polyurethane article is removed from the mold.

The mold release composition remains adhered to the mold and surprisingly does not adhere to the surface of the polyurethane molded article. Thus the mold may be used to produce multiple molded articles, and multiple releases from the mold are achieved without reapplying the mold release composition to the mold.

The surface of the molded article is free of mold release composition and can be painted or otherwise coated without the need for chemical or physical cleaning.

There is further provided a process to prepare a painted polyurethane molded article comprising providing a mold release composition comprising a volatile siloxane solvent and a combination of a polysilsesquioxane polymer or copolymer and a functionally-terminated polydimethylsiloxane, to produce a mold release composition; applying the mold release composition onto a mold, charging to the treated mold a reactive polyurethane system; rotating the mold to form a molded polyurethane article within the mold; removing the molded polyurethane article from the mold wherein the mold release composition does not adhere to the surface of the article; and painting the molded article without chemically or physically cleaning the article prior to painting. Optionally the mold release composition further comprises a catalyst, a co-solvent, or both. Optionally the process further comprises curing the mold release composition after it has been applied to the mold. Optionally the treated mold may be heated after charging the polyurethane system to the treated mold. Optionally the mold is cooled after forming the molded polyurethane article within the mold.

### EXAMPLES

### Comparative Example A

This example demonstrates the use of octyltrisiloxane as the volatile siloxane in a ready-to-paint release agent for rotomolding polyurethane with a functionally-terminated polydimethylsiloxanes in the absence of a polysilsesquioxane did not provide a release coating on a mold with adequate release properties for rotomolded polyurethane.

Five release agent compositions, A, B, C, D and E were prepared by mixing the components provided below, in Table 1.

TABLE 1

| | A | B | C | D | E |
|---|---|---|---|---|---|
| Component | wt % | wt % | wt % | wt % | wt % |
| Octamethyl trisiloxane | 29.1 | 29.0 | 29.0 | 28.81 | 28.77 |
| Exxon ISOPAR G(a) | 67.9 | 67.9 | 67.4 | 67.22 | 67.13 |
| Trimethoxy-terminated | 2.25 | 2.25 | 2.25 | 2.24 | 2.25 |
| polydimethylsiloxane (viscosity = 71,000 cps) | | | | | |
| Trimethoxy-terminated | 0.75 | 0.75 | 0.75 | 0.74 | 0.75 |
| polydimethylsiloxane (viscosity = 20,000 cps) | | | | | |
| Monohydroxy-terminated | 0 | 0 | 0 | 0 | 1 |
| polydimethylsiloxanes (viscosity = 50,000 cps) | | | | | |
| Methyltricyclohexyl aminosilane | 0 | 0 | 0.5 | 0 | 0 |
| Dow Corning 204, alkylaryl | 0 | 0 | 0 | 1 | 0 |
| polysiloxane fluid | | | | | |
| TYZOR DC organic titanate | 0 | 0.1 | 0.1 | 0 | 0.1 |
| Total, amount, wt % | 100 | 100 | 100 | 100 | |

(a)Exxon ISOPAR G is an isoparaffinic solvent available from Exxon Mobil Corporation, Fairfax, VA.

The coatings were applied using a Preval spray gun on to carbon steel test plates preheated to 65° C. The coating was allowed to cure for 5 minutes at 65° C. Rotomolding grade polyurethane was prepared by mixing 26 grams of 37456A isocyanate with 24 grams of 37456B polyol, both available from T.A. Davies Corp., Rancho Dominguez, Calif. A small section of the polyurethane was poured onto each plate and allowed to harden for 10 minutes while the plate was maintained at 65° C. in an oven.

After curing, for each of the plates treated with compositions A-E, the polyurethane was found to be difficult to release from the plate surface.

### Example 1

This example demonstrates the use of octamethyltrisiloxane in combination with octamethylcyclotetrasiloxane as the volatile siloxane components in a ready-to-paint release agent for rotomolding polyurethane.

The following release agent composition was prepared by mixing the components.

| Component | wt % |
|---|---|
| Octamethylcyclotetrasiloxane | 9.21 |
| Octamethyltrisiloxane | 27.62 |
| Exxon ISOPAR G | 55.23 |
| Polysilsesquioxane copolymer (a) | 3.66 |
| Monohydroxy-terminated polydimethylsiloxanes (b) | 2.40 |
| Methyltricyclohexylaminosilane | 1.00 |
| TYZOR DC organic titanate | 0.22 |
| Dibutyltin diacetate | 0.66 |

(a) Polymethoxy methylsiloxane/methyl silsesquioxane copolymer containing approximately 25% methoxy groups by weight and having a viscosity of 30 cps.
(b) Polysiloxane has viscosity of 50,000 cps.

Three spray coatings were applied to a fiberglass manikin mold preheated to 46° C. Three minutes were allowed between coatings for the solvent to evaporate and for the coating to cure. The release agent of this invention cured into a solid film that adhered to the mold surface and did not transfer to the manikin. The mold was assembled and reheated to 43° C. The urethane was poured into the mold and was rotomolded for 20 minutes. The mold was then opened and the part removed. The mold was reassembled and a second part was molded without recoating the mold. The second part was removed after being rotomolded for 20 minutes. Both parts were painted without chemical or physical cleaning. The painted parts were visually examined. No defects in the paint were observed.

### Comparative Example B

A silicone emulsion comprising a silicone oil without functional groups was applied to a fiberglass manikin mold following the manufacturer's instructions. This release agent did not appear to generate a solid film. Urethane was poured into the mold and rotomolded. The resulting molded manikin appeared to have some of the release agent adhering to its surface. Painting of the finished, as-molded manikin resulted in defects such as fisheyes on the painted surface. To achieve a defect-free painted surface required sandblasting of the manikin prior to painting.

### Comparative Example C

This example demonstrates that coatings containing fluorinated additives do not provide adequate release for rotomolded polyurethane. Various ZONYL fluorinated compounds, known to provide release properties to surfaces were applied to room temperature steel plates using a Preval spray gun. The plates were allowed to cure for 10 minutes at the temperature shown in Table 2.

TABLE 2

| | A | B | C | D | Cure |
|---|---|---|---|---|---|
| | wt % | wt % | wt % | wt % | Temperature |
| Zonyl 565 | 100 | | | | 65° C. |
| Zonyl 9155 | | 100 | | | room temp |
| Zonyl 9529 | | | 100 | | room temp |
| Zonyl 9933 | | | | 100 | room temp |

Rotomolding grade polyurethane was prepared by mixing 26 grams of 37456A isocyanate with 24 grams of 37456B polyol, both available from T.A. Davies Corp, Rancho Dominguez, Calif. A small section of the polyurethane was poured onto each plate and allowed to harden for 10 minutes while the plate was maintained at 65° C. in an oven or at room temperature. After curing, the polyurethane was found difficult to release from the plate surface.

What is claimed is:

1. A mold release composition comprising (a) at least one volatile siloxane solvent and (b) a combination of a polysilsesquioxane polymer or copolymer and a functionally-terminated polydimethylsiloxane.

2. A composition according to claim 1 further comprising a catalyst, a co-solvent, or both.

3. A composition according to claim 1 further comprising a catalyst and a co-solvent.

4. A composition according to claim 1 wherein the volatile siloxane solvent is selected from the group consisting of hexamethyldisiloxane, hexamethylcyclotrisiloxane, 2,5-dichloro-1,1,3,3,5,5,-hexamethyltrisiloxane, 1,3-dimethyltetramethoxydisiloxane, 1,1,1,3,5,5,5,-heptamethyltrisiloxane, 3-(heptafluoropropyl)trimethysiloxane, octamethyltrisiloxane, octamethyltetrasiloxane, octamethylcyclotetrasiloxane, decamethyltetrasiloxane, decamethylcyclopentasiloxane, dodecamethylpentasiloxane, and dodecamethylcyclohexasiloxane, and combinations of two or more thereof.

5. A composition according to claim 1 wherein the polysilsesquioxane polymer or copolymer is a polyalkyl- or polyarylsilsesquioxane, wherein alkyl is hydrogen, methyl or ethyl and aryl is phenyl.

6. A composition according to claim 1 wherein the polysilsesquioxane polymer or copolymer is a copolymer of methylsilsesquioxane and phenylsilsesquioxane.

7. A composition according to claim 1 wherein the polysilsesquioxane is a copolymer of a silsesquioxane and a functionally-terminated siloxane.

8. A composition of claim 1 wherein the functionally-terminated polydimethylsiloxane is a mono- or di-hydroxy- or mono- or di-methoxy-terminated polydimethylsiloxane, or a combination thereof.

9. A method to provide a paint-ready polyurethane molded article comprising (a) combining a volatile siloxane solvent, a combination of a polysilsesquioxane polymer or copolymer and a functionally-terminated polydimethylsiloxane, to produce a mold release composition; (b) applying the mold release composition onto a mold, (c) charging to the mold a reactive polyurethane system; (d) rotating the mold to form a molded polyurethane article within the mold; and (f) removing the molded polyurethane article from the mold wherein the mold release composition does not adhere to the surface of the article.

10. A method according to claim 9 wherein said mold release composition further comprises a catalyst and a co-solvent.

11. A method according to claim 9 wherein the volatile siloxane solvent is selected from the group consisting of hexamethyldisiloxane, hexamethylcyclotrisiloxane, 2,5-dichloro-1,1,3,3,5,5,-hexamethyltrisiloxane, 1,3-dimethyltetramethoxydisiloxane, 1,1,1,3,5,5,5,-heptamethyltrisiloxane, 3-(heptafluoropropyl)trimethysiloxane, octamethyltrisiloxane, octamethyltetrasiloxane, octamethylcyclotetrasiloxane, decamethyltetrasiloxane, decamethylcyclopentasiloxane, dodecamethylpentasiloxane, and dodecamethylcyclohexasiloxane, and combinations of two or more thereof.

12. A method according to claim 11 wherein the polysilsesquioxane polymer or copolymer is a copolymer of methylsilsesquioxane and phenylsilsesquioxane and the functionally-terminated polydimethylsiloxane is a mono- or di-hydroxy- or mono- or di-methoxy-terminated polydimethylsiloxane, or a combination thereof.

13. A method according to claim 11 wherein the polysilsesquioxane is a copolymer of a silsesquioxane and a functionally-terminated siloxane and the functionally-terminated polydimethylsiloxane is a mono- or di-hydroxy- or mono- or di-methoxy-terminated polydimethylsiloxane, or a combination thereof.

14. A method to provide a paint-ready polyurethane molded article comprising (a) combining a volatile siloxane solvent, a combination of a polysilsesquioxane polymer or copolymer and a functionally-terminated polydimethylsiloxane, and a catalyst to produce a mold release composition; (b) applying the mold release composition onto a mold, (c) curing the mold release composition; (d) charging to the mold a reactive polyurethane system; (e) rotating the mold while heating to form a molded polyurethane article within the mold; (f) allowing the mold to cool while rotating the mold; and (g) removing the molded polyurethane article from the mold wherein the mold release composition does not adhere to the surface of the article.

15. A process to prepare a painted polyurethane molded article comprising: (a) providing a mold release composition comprising a volatile siloxane solvent and a combination of a polysilsesquioxane polymer or copolymer and a functionally-terminated polydimethylsiloxane, to produce a mold release composition; (b) applying the mold release composition onto a mold; (c) charging to the treated mold a reactive polyurethane system; (d) rotating the mold to form a molded polyurethane article within the mold; (e) removing the molded polyurethane article from the mold wherein the mold release composition does not adhere to the surface of the article; and (f) painting the molded article without chemically or physically cleaning the article prior to painting.

16. A process according to claim 15 wherein the mold release composition further comprises a catalyst, a co-solvent, or both.

17. A process according to claim 16 further comprising curing the mold release composition after it has been applied to the mold.

18. A process according to claim 16 further comprising heating the treated mold while rotating after charging the polyurethane system to the treated mold.

19. A process according to claim 16 further comprising cooling the mold after forming the molded polyurethane article within the mold.
